(19) United States
(12) Patent Application Publication
(10) Pub. No.: US 2026/0127055 A1
(43) Pub. Date: May 7, 2026

(54) DYNAMIC MAINTENANCE OF CLOUD INFRASTRUCTURE FOR MITIGATING PREDICTED OUTAGES

(71) Applicant: Charter Communications Operating, LLC, St. Louis, MO (US)

(72) Inventors: Ramandeep Singh, Parker, CO (US); Khaled Elbehiery, Englewood, CO (US)

(21) Appl. No.: 18/936,250

(22) Filed: Nov. 4, 2024

(51) Int. Cl. G06F 11/00; G06N 3/0475

(52) U.S. Cl. CPC G06F 11/004; G06N 3/0475; G06F 2201/805

(57) ABSTRACT

A plurality of log entries for a respective plurality of modules of a cloud computing platform are processed with a machine-learned Large Foundational Model (LFM) to obtain a prediction output. The prediction output is indicative of a predicted outage event for the cloud computing platform and a corresponding degree of severity. Based on the prediction output, a target module of the plurality of modules of the cloud computing platform is identified. A plurality of modifications is generated for a configuration of the target module with the machine-learned LFM. The plurality of modifications is configured to mitigate the predicted outage event. The plurality of modifications is based at least in part on the degree of severity. The plurality of modifications is deployed to the configuration of the target module.

### BACKGROUND

“Cloud computing” refers to the provision of computing services over the internet, such as hosting, storage, databases, networking, software, and analytics, etc. Cloud computing platforms enable real-time access to these resources on-demand, without needing to invest in physical infrastructure, enabling scalability, flexibility, and cost savings. Cloud computing platforms are often modular, and can be scaled dynamically to meet demand.

Cloud computing platforms generally provide access to much larger quantities of computing resources than would be available to most organizations otherwise. For example, assume that one organization hosts online services locally using a local on-premises server device, and another organization hosts services via a cloud computing service. Further assume that the services provided by both organizations experience substantial spikes in demand. If the demand exceeds the capacity of the local on-premises server, the performance of the services can be severely degraded. However, if the demand exceeds the current capacity provided by the cloud computing platform, the cloud computing platform can dynamically allocate additional capacity to mitigate performance degradation.

### SUMMARY

Cloud computing platforms can experience outages due to faults or the like at certain cloud modules. Logging entries from such platforms can be processed with a machine-learned model to obtain a prediction output indicating a predicted outage event for the cloud platform. Based on the prediction output, a target cloud module can be identified (e.g., a causative module, an impacted module, etc.). A plurality of modifications can be generated for a configuration of the target module to mitigate the outage event. The modifications can be deployed to the target module.

In one implementation, a method is provided. The method includes processing, by a computing system comprising one or more processor devices, a plurality of log entries for a respective plurality of modules of a cloud computing platform with a machine-learned Large Foundational Model (LFM) to obtain a prediction output, wherein the prediction output is indicative of a predicted outage event for the cloud computing platform and a corresponding degree of severity. The method further includes identifying, by the computing system based on the prediction output, a target module of the plurality of modules of the cloud computing platform. The method further includes, for the target module, generating, by the computing system with the machine-learned LFM, a plurality of modifications for a configuration of the target module, wherein the plurality of modifications is configured to mitigate the predicted outage event, and wherein the plurality of modifications is based at least in part on the degree of severity. The method further includes, for the target module, deploying, by the computing system, the plurality of modifications to the configuration of the target module.

In another implementation, a computing system is provided. The computing device includes a memory, and one or more processor devices coupled to the memory. The one or more processor devices are to process a plurality of log entries for a respective plurality of modules of a cloud computing platform with a machine-learned Large Foundational Model (LFM) to obtain a prediction output, wherein the prediction output is indicative of a predicted outage event for the cloud computing platform and a corresponding degree of severity. The one or more processor devices are further to identify, based on the prediction output, a target module of the plurality of modules of the cloud computing platform. The one or more processor devices are further to, for the target module, generate, with the machine-learned LFM, a plurality of modifications for a configuration of the target module, wherein the plurality of modifications is configured to mitigate the predicted outage event, and wherein the plurality of modifications is based at least in part on the degree of severity. The one or more processor devices are further to, for the target module, deploy the plurality of modifications to the configuration of the target module.

In another implementation, a non-transitory computer-readable storage medium is provided. The non-transitory computer-readable storage medium includes executable instructions to cause one or more processor devices to process a plurality of log entries for a respective plurality of modules of a cloud computing platform with a machine-learned Large Foundational Model (LFM) to obtain a prediction output, wherein the prediction output is indicative of a predicted outage event for the cloud computing platform and a corresponding degree of severity. The instructions further cause the one or more processor devices to identify, based on the prediction output, a target module of the plurality of modules of the cloud computing platform. The instructions further cause the one or more processor devices to, for the target module, generate, with the machine-learned LFM, a plurality of modifications for a configuration of the target module, wherein the plurality of modifications is configured to mitigate the predicted outage event, and wherein the plurality of modifications is based at least in part on the degree of severity. The instructions further cause the one or more processor devices to, for the target module, deploy the plurality of modifications to the configuration of the target module.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment suitable for implementing dynamic maintenance of cloud infrastructure to mitigate predicted outage events according to some implementations of the present disclosure.

FIG. 2 is a data flow diagram for dynamically mitigating the impact of a predicted outage event on a cloud computing platform by modifying the configuration of impacted and causative cloud modules according to some implementations of the present disclosure.

FIG. 3 is a data flow diagram data flow diagram for training a machine-learned model to parse module-specific log entries for predicting outage events on a cloud computing platform according to some implementations of the present disclosure.

FIG. 4 depicts a flow chart diagram of an example method to perform dynamic mitigation of cloud infrastructure to mitigate predicted outages according to some implementations of the present disclosure.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Cloud computing refers to the provision of computing services over the internet, such as hosting, storage, databases, networking, software, and analytics, etc. Cloud computing platforms enable real-time access to these resources on-demand, without needing to invest in physical infrastructure, enabling scalability, flexibility, and cost savings. Cloud computing platforms are often modular, and can be scaled dynamically to meet demand.

Cloud computing platforms generally provide access to much larger quantities of computing resources than would be available to most organizations otherwise. For example, assume that one organization hosts online services locally using a local on-premises server device, and another organization hosts services via a cloud computing service. Further assume that the services provided by both organizations experience substantial spikes in demand. If the demand exceeds the capacity of the local on-premises server, the performance of the services can be severely degraded. However, if the demand exceeds the current capacity provided by the cloud computing platform, the cloud computing platform can dynamically allocate additional capacity to mitigate performance degradation.

Like on-premises servers, cloud computing systems must be maintained regularly. Maintenance for cloud systems involves regular updates, security patches, performance monitoring, and optimization to ensure efficient and secure operation. This includes tasks like managing data backups, addressing potential vulnerabilities, and ensuring high availability through redundancy and failover strategies. Cloud maintenance is often managed by service providers but can also require user oversight, depending on the service model.

Although cloud computing platforms are generally more resistant to severe outages than their on-premises counterparts, it is still relatively common for outages to occur. However, the scale and dynamic nature of cloud systems can make it difficult to identify the root cause of such outages. For example, failure of a particular device, such as a network card, is relatively simple to diagnose in on-premises systems as the location of each device is known. For cloud systems, however, the physical devices used to implement such services may be widely distributed across a number of different locations. Further, the use of virtualization technologies that enable the dynamic scaling of cloud services can also cause outages that do not occur in on-premises systems. As such, it can be prohibitively difficult to identify the cause of outages for cloud computing platforms.

Cloud computing platform outages can be substantially impactful, as one outage has the potential to affect large numbers of users who utilize the cloud computing platform. For example, if one computing device within the cloud computing platform is being used to provide cloud services to multiple users, an outage at the computing device may affect each of those users. The capability to perform preventative or mitigating actions prior to occurrence of a predicted outage event is greatly desired. However, to do so, a cloud computing platform must accurately identify the modules responsible for causing the predicted outage event, and then deploy mitigations to those modules. Thus, without the ability to accurately identify the cause of cloud service outages, cloud computing platforms cannot perform necessarily difficult to perform preventative maintenance actions (e.g., deploying mitigations) prior to the occurrence of a cloud service outage.

Accordingly, implementations described herein propose dynamic maintenance for cloud infrastructure to mitigate predicted outages. More specifically, a computing system (e.g., a cloud computing platform, a computing system within a cloud computing platform, etc.) can obtain a plurality of log entries from a plurality of cloud modules. As described herein, a cloud “module” can refer to any collection of hardware and/or software resources necessary to implement a particular functionality within the cloud computing platform.

Examples of cloud modules can include an Artificial Intelligence (AI)/Machine learning (ML) module, compute module, storage module, network/security module, virtualization module, etc. For example, an AI/ML module may include a machine-learned model, a model trainer, optimization algorithms, loss functions, training datasets, etc.

The log entries from each of the modules can be processed using one or more machine-learned models. As described herein, a “log entry” can refer to one or more portions of information that are associated with a particular cloud module. A log entry may be, include, or describe an output of a module, an operation performed by a module, data obtained by a module, performance measurements for a module, resource utilization for a module, etc. A log entry can refer to some, or all, of a “log” conventionally generated during typical operation of a software module. For example, assume that continuous logging is performed for a cloud module so that an entry is routinely generated for the continuous log every minute. In this instance, a “log entry” may refer to one or more of the entries or the continuous log itself.

In some implementations, the log entries can be processed by machine-learned models trained specifically to evaluate log entries of a particular module. For example, one model may be trained to evaluate log entries from an AI/ML module while another model is trained to evaluate log entries from a virtualization module (i.e., virtualization-related logs). Additionally, or alternatively, in some implementations, a model can be used to process logs from multiple modules. For example, a Large Foundational Model (LFM) (e.g., a Large Language Model (LLM), etc.) can evaluate a log entry from a virtualization module alongside contextual information associated with virtualization technologies (e.g., a corpus of contextual information that enables accurate evaluation of the log entries). The model can then evaluate a log from an AI/ML module alongside contextual information associated with AI/ML technologies.

The computing system can process the log entries with the machine-learned model(s) to obtain a prediction output. The prediction output can indicate a predicted outage event that is predicted to occur imminently or in the near future. The prediction output can also indicate a predicted degree of severity for the predicted outage. For example, the prediction output may indicate that a particular module (or service provided by the module), or the cloud platform itself, is likely to experience a severe outage imminently. Based on the prediction output, the computing system can identify one or more target modules of the plurality of modules of the cloud computing platform.

In some implementations, a “target” module can refer to a module affected by the predicted outage. Additionally, or alternatively, in some implementations, the “target” module can refer to a module predicted to be causative of the predicted outage rather than a module affected by the outage. For a specific example, assume that the prediction output indicates that a storage module of the cloud computing platform is likely to experience an imminent outage. Although the storage module is identified by the prediction output as the affected module, the causative module may be different. For example, a malicious actor may gain access to the AI/ML module and use the AI/ML module to maliciously store large quantities of redundant data to the storage module, thus causing the failure.

The computing system can generate a plurality of modifications for a configuration of the target module. The modifications can be configured to mitigate the predicted outage event, and can be based at least in part on the degree of severity. For example, the modifications generated for a relatively “minor” outage may be different (e.g., less drastic, etc.) than those generated for a severe outage.

The computing system can deploy the modifications to the configuration of the target module. In some implementations, the computing system can deploy the modifications prior to occurrence of the predicted outage event. For example, if the prediction output indicates that the storage module of the cloud platform is likely to experience an outage due to a failure detected in the network module, the computing system can deploy modifications to the network module and/or the storage module to mitigate the predicted outage. In such fashion, implementations described herein can perform dynamic maintenance for cloud infrastructure to mitigate predicted outages.

Aspects of the present disclosure provide a number of technical effects and benefits. As one example technical effect and benefit, implementations described herein can mitigate the effects of cloud platform outages and/or avoid predicted cloud outages before they occur. Generally, substantial quantities of computing resources are necessary to repair or remedy cloud platform outages (e.g., power, memory, storage, compute cycles, etc.). For example, AI/ML workloads require substantial computing resources, and if the AI/ML module of a cloud computing platform experiences an outage during performance of a workload, the workload generally must be restarted, thus requiring substantially more resource usage. For another example, if the storage module of the cloud computing platform experiences an outage, some (or all) of the data stored to the storage device must be relocated to a different location, thus requiring substantial bandwidth usage. As such, by reducing the effects and/or occurrence of cloud platform outages, implementations described herein reduce, or eliminate, the associated utilization of computing resources.

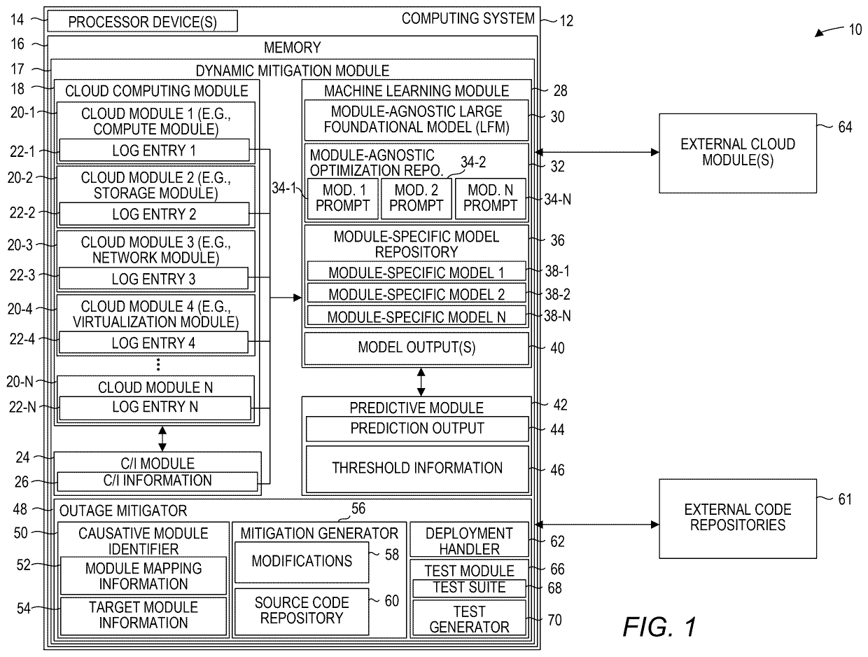

FIG. 1 is a block diagram of a computing environment 10 suitable for implementing dynamic maintenance of cloud infrastructure to mitigate predicted outage events according to some implementations of the present disclosure. A computing environment 10 can include a computing system 12 with one or more processor device(s) 14 and a memory 16. As described herein, the “computing environment” 10 can be any type or manner of computing environment (e.g., a collection of computing devices, systems, and related infrastructure associated with a particular entity or organization), such as a “confidential” computing environment in which sensitive data and code is protected during processing, a “public” computing environment, etc. For example, the computing environment 10 can be or otherwise include a confidential computing “enclave” that leverages hardware-based TEEs and secure virtualization technologies, such as memory encryption, to isolate critical computations and prevent unauthorized access to data while in use. For another example, the computing environment 10 can be a distributed computing environment that utilizes computing resources across a variety of different types of devices (e.g., servers, virtualized devices, user devices, Internet-of-Things (IoT) devices, etc.).

Additionally, or alternatively, in some implementations, the computing environment 10 can be a cloud computing environment implemented using the computing system 12. For example, the computing system 12 can implement a cloud computing platform by implementing a variety of cloud modules to provide cloud functionality. The cloud computing platform implemented by the computing system 12 can be utilized by various users, entities, organizations, devices, etc. within (and/or external to) the computing environment 10.

In some implementations, the computing system 12 may be a computing system that includes multiple computing devices. Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 10 can include multiple types of nodes. As described herein, a “node” generally refers to a discrete unit of hardware and/or software resources. In some instances, nodes within the computing environment 10 can be configured to perform specific tasks. For example, some nodes within the computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

In some implementations, the computing environment 10 can be, or otherwise include, a software development environment. The computing environment 10 can include computing device(s), system(s), etc. that are utilized for developing software. For example, the computing system 12 can be a system for creating (i.e., developing) and/or maintaining a large software project (e.g., an application. To do so, the computing system 12 may maintain a codebase for the large software project, a code versioning system and/or versioning information for the codebase, etc.

The memory 16 of the computing system 12 can include a dynamic mitigation module 17. The dynamic mitigation module 17 can perform operations to dynamically mitigate outages predicted to occur within a cloud computing platform 18. It should be noted that the cloud computing platform 18 is illustrated as a component of the dynamic mitigation module 17 only to more easily illustrate various implementations of the present disclosure. Rather, the cloud computing platform 18 can be implemented on the some (or all) of the memory 16 as the dynamic mitigation module 17, a different memory than the memory 16, etc.

The cloud computing platform 18 can be utilized to provide cloud computing services to users, entities, organizations, etc. For example, the cloud computing platform 18 may provide cloud computing services to a user by hosting an application created by the user. For another example, the cloud computing platform 18 may implement virtually accessible machines for members of an organization so that the machines can be accessed anywhere.

To do so, the cloud computing platform 18 can include cloud modules 20-1-20-N (generally, cloud modules 20). Each of the cloud modules 20 can implement different services or functions of the cloud computing platform 18. Examples of the cloud modules 20 included in the cloud computing platform 18 can include a compute module, storage module, network/security module, virtualization module, configuration module, etc.

Each of the cloud modules 20 can be implemented by the cloud computing platform 18 during operation of the cloud computing platform 18. Specifically, in some implementations, each of the cloud modules 20 can collectively form the cloud computing platform 18 in a distributed manner. Additionally, or alternatively, in some implementations, the cloud modules 20 can be components or portions of the cloud computing platform 18.

The cloud modules 20 can respectively generate a plurality of log entries 22-1-22-N (generally, log entries 22) during operation of the cloud modules 20. Additionally, or alternatively, in some implementations, the cloud modules 20 can be monitored by a logging module or the like that is configured to generate the log entries 22 for the cloud modules 20. The log entries 22 for the cloud modules 20 can describe prior operations, errors, events, resource usage, etc. for each of the respective cloud modules 20.

In some implementations, the cloud modules 20 can include a compute module, such as a cloud compute module 20-1 that handles compute-related tasks or otherwise implements compute-related functionality for the cloud computing platform 18. Specifically, the cloud compute module 20-1 can provide necessary infrastructure for running computational tasks, processing data, executing applications, completing compute-related tasks, etc. The cloud compute module 20-1 may be leveraged within the cloud computing platform 18 to host web and application servers, process data, perform data analytics, train and/or utilize machine-learned models, high-performance computing, etc. In addition, resources or infrastructure provided by the cloud compute module 20-1 can be dynamically scaled to meet demand while being abstracted from the user. For example, given a task by a user, the cloud compute module 20-1 may dynamically adjust the resources allocated for completion of the task. The log entry 22-1 can log operations, errors, events, resource usage, etc. for the cloud compute module 20-1 (e.g., compute resource usage, compute task completion, etc.).

Additionally, or alternatively, in some implementations, the cloud modules 20 can include a cloud storage module 20-2 that handles storage-related tasks or otherwise implements storage-related functionality for the cloud computing platform 18. Specifically, the cloud storage module 20-2 can provide data storage capabilities for users of the cloud computing platform 18. Other modules of the cloud modules 20 within the cloud computing platform 18 can interface with the cloud storage module 20-2 to complete various tasks or implement various functions. For example, if the cloud compute module 20-1 is instructed to process a dataset for data analytics, and the dataset is stored to the cloud storage module 20-2, the cloud compute module 20-1 can interface with the cloud storage module 20-2 to retrieve the dataset. The cloud storage module 20-2 enables storage, retrieval, management, and preservation (i.e., backup services) of data in a scalable manner. The cloud storage module 20-2 can store information in accordance with various storage modalities, such as object-based storage (e.g., storing unstructured data such as images, videos, etc.), block-based storage (e.g., raw storage volumes that are attached to virtual machines), and/or file-based storage (e.g., a file system accessible over standard protocols). The log entry 22-2 can log operations, errors, events, resource usage, etc. for the cloud storage module 20-2 (e.g., storage resource usage, storage task completion, storage resource availability, etc.).

Additionally, or alternatively, in some implementations, the cloud modules 20 can include a cloud network/security module 20-3. The cloud network/security module 20-3 can include physical infrastructure (e.g., wires, switches, routers, etc.), virtualized infrastructure (e.g., virtual networks, virtualized processing devices, virtualized network devices, etc.), and security infrastructure (e.g., firewalls, active directories, identity/access management gateways, etc.). In addition, the cloud network/security module 20-3 can provide various cloud networking functions (e.g., virtual private networks, subnetting, routing tables, network security groups, load balancing, Content Delivery Networks (CDNs), traffic monitoring, etc.) and security functions (e.g., Distributed Denial of Service (DDoS) protection, intrusion detection, multi-factor authentication, endpoint protection, certificate management, etc.). Such functions can be used to implement the cloud computing platform 18 or can otherwise be provided by the cloud computing platform 18. The log entry 22-3 can log operations, errors, events, resource usage, etc. for the cloud network/security module 20-3 (e.g., network/security resource usage, network/security task completion, network/security resource availability, etc.).

It should be noted that the cloud network/security module 20-3 is illustrated as providing both network-related and security-related functions only to more clearly illustrate various implementations of the present disclosure. In other implementations, the functionality implemented with the cloud network/security module 20-3 can be implemented by separate cloud network modules and cloud security modules.

Additionally, or alternatively, in some implementations, the cloud modules 20 can include a cloud virtualization module 20-4. The cloud virtualization module 20-4 can implement various virtualization functions within the cloud computing platform 18, such as hypervisor management, instance creation (e.g., virtual machine instances, container instances, etc.), image management, automatic scaling, instance isolation, orchestration, resource allocation, etc. Such functions can be used to implement the cloud computing platform 18 or can otherwise be provided by the cloud computing platform 18. The log entry 22-4 can log operations, errors, events, resource usage, etc. for the cloud virtualization module 20-4 (e.g., virtualization resource usage, virtualization task completion, virtualization resource availability, etc.).

In some implementations, the cloud computing platform 18 can include a configuration/implementation (C/I) module 24. The C/I module 24 can manage configuration and implementation of the cloud modules 20. In particular, the C/I module 24 can include C/I information 26. The C/I information 26 can include a combination of configuration data and implementation strategies that define how resources are provisioned, managed, and scaled within a cloud environment. Configuration, deployment, adjustment, etc. of the cloud modules 20 can be accomplished via automated processes, and can be managed through Infrastructure as Code (laC) tools and practices, which allow for the consistent and repeatable deployment of cloud resources.

In particular, the C/I module 24 can dynamically apply or otherwise deploy modifications to the configurations of the cloud modules 20. For example, if the cloud virtualization module 20-4 is configured to instantiate virtual machine instances of a particular type by default, and a vulnerability is discovered with that type of virtual machine instance, the C/I module 24 can receive information describing modifications to the configuration of the cloud virtualization module 20-4 so that the cloud virtualization module 20-4 utilizes a different type of virtualized instance by default. The C/I module 24 can then deploy or apply those modifications to the cloud virtualization module 20.4

Additionally, or alternatively, in some implementations, the cloud modules 20 can include additional and/or different cloud modules than those described above (e.g., the cloud compute module 20-1, the cloud storage module 20-2, the cloud network/security module 20-3, the cloud virtualization module 20-4, etc.). For example, the cloud modules 20 may include modules specific to certain use-cases, such as an encryption module for encrypting sensitive information, a localization module to handle localization of hosted content, third-party modules to implement third-party applications or services, etc.

The dynamic mitigation module 17 can include a machine learning module 28. The machine learning module 28 can handle various tasks and responsibilities for implementing machine-learned models. Examples of such tasks and responsibilities include model storage, model training, model fine-tuning, model optimization, federated learning tasks, training data reporting tasks, etc. For example, the machine learning module 28 can train machine-learned models to evaluate the log entries 22 from the cloud modules 20.

In some implementations, the machine learning module 28 can include a module-agnostic Large Foundational Model (LFM) 30. As described herein, a LFM refers to a machine-learned model with a particular quantity of parameters and/or training iterations that enables the LFM to perform multiple types of tasks. Examples of LFMs generally include Large Language Models (LLMs), Large Vision Models (LVMs), large multimodal models, etc.

In some implementations, the module-agnostic LFM 30 can be utilized to evaluate some (or all) of the log entries 22. Specifically, in some implementations, the module-agnostic LFM 30 can be capable of evaluating different types of log entries from different cloud modules 20. For example, the machine learning module 28 can include a module-agnostic optimization repository 32. The module-agnostic optimization repository 32 can include a plurality of model prompts 34-1-34-N (generally, model prompts 34). Each of the model prompts 34 can instruct the module-agnostic LFM 30 how to evaluate a corresponding type of log entry of the log entries 22. For example, the model prompt 34-1 can prompt the module-agnostic LFM 30 to evaluate the log entry 22-1 for the cloud compute module 20-1 based on certain compute-specific criteria, the model prompt 34-2 can prompt the module-agnostic LFM 30 to evaluate the log entry 22-2 for the cloud network/security module 20-3 based on certain network/security-specific criteria, etc.

In some implementations, the model prompts 34 can include contextual information associated with a corresponding type of log entry. The contextual information can be associated with (or otherwise describe) the function of a particular module of the cloud modules 20 (e.g., a compute function, a storage function, a network/security function, a virtualization function, a configuration function, etc.). For example, assume that the model prompt 34-1 prompts the module-agnostic LFM 30 to evaluate the log entry 22-1 for the cloud compute module 20-1. The model prompt 34-1 may also include compute-specific contextual information, such as evaluation criteria, example evaluation metrics (e.g., an “optimal” degree of resource usage, temperatures, device utilization, etc.), previous examples of compute-specific log entries and corresponding evaluations, etc. For another example, the model prompt 34-2 may include storage-specific contextual information, such as current utilization information, available storage device information, compression schemas, data degradation metrics, etc. For another example, the model prompt 34-3 may include network/security-specific contextual information, such as known vulnerabilities, malicious actor reports, security standards information, security framework compliance information, real-time threat monitoring information, etc. For yet another example, the model prompt 34-4 may include virtualization-specific contextual information, such as a hypervisor configuration, VM configuration, container configuration, virtualization documentation, etc.

Additionally, or alternatively, in some implementations, the machine learning module 28 can include a module-specific model repository 36. The module-specific model repository 36 can include a plurality of module-specific models 38-1-38-N (generally, module-specific models 38). The module-specific models 38 can be models capable of parsing log entries and trained to understand and learn from specific types of log entries, enhancing predictive analytics and decision-making. Each of the module-specific models 38 can be a machine-learned model (or instance thereof) trained, prompted, fine-tuned, optimized, or otherwise configured to evaluate log entries obtained for a specific cloud module. For example, the module-specific model 38-1 can be trained to process the log entry 22-1 from the cloud compute module 20-1 while the module-specific model 38-2 can be trained to process the log entry 22-2 from the cloud storage module 20-2.

The machine learning module 28 can include model output(s) 40. The model outputs 40 can be obtained from the module-specific models 38 and/or the module-agnostic LFM 30 in response to processing the log entries 22 with the model(s). For example, the module-agnostic LFM 30 may be utilized to process the log entry 22-1 and the log entry 22-2 to obtain two model output(s) respectively. For another example, the module-agnostic LFM 30 may be utilized to process each of the log entries 22 to obtain a single model output. For yet another example, each of the module-specific models 38 can be utilized to process a corresponding log entry 22 to obtain a model output of the model output(s) 40.

In some implementations, the model output(s) 40 can be, or otherwise include, parsing output(s) that parse the log entries 22 to identify relevant metrics or portions of information (e.g., metrics that are outside a normal range, reported errors, faults, etc.). Additionally, or alternatively, in some implementations, the model output(s) 40 can be predictive outputs that predict whether a fault is likely to occur for the cloud module for which the log entry was created. For example, the module-specific model 38-1 may process the log entry 22-1 to generate a model output indicating that either (a) a fault, error, disruption of service, etc. is likely to occur imminently for the cloud compute module 20-1, or (b) has recently occurred at the cloud compute module 20-1.

The dynamic mitigation module 17 can include a predictive module 42. The predictive module 42 can generate a prediction output 44. The prediction output 44 can be indicative of a predicted outage event for the cloud computing platform 18 and a corresponding degree of severity. As described herein, an “outage event” can refer to a period of time in which the cloud computing platform 18, or certain cloud modules 20 of the cloud computing platform 18, are non-functional or are operating at a level of reduced functionality.

In some implementations, the prediction output 44 can indicate a predicted time of occurrence for the outage event. Additionally, or alternatively, in some implementations, the prediction output 44 can indicate a type of predicted outage (e.g., complete outage, partial outage for certain functions or services, etc.). Additionally, or alternatively, in some implementations, the prediction output 44 can indicate a predicted duration of the predicted outage.

In some implementations, the degree of severity indicated by the prediction output 44 can be a “tiered” classification of severity (e.g., low severity, medium severity, high severity, etc.). In some implementations, the degree of severity indicated by the prediction output 44 can be based on threshold information 46. The threshold information 46 can classify a severity of an outage event. For example, the threshold information 46 can indicate that an outage with a predicted duration of more than one minute is classified as “medium severity” while an outage with a predicted duration of more than one hour is classified as “high severity.” In addition to (or alternatively to) the predicted duration, the threshold information can also classify outages based on other metrics, such as the number of cloud modules affected, the type of outage (e.g., damage to physical hardware versus a software fault), historical fault information describing prior faults, etc.).

The dynamic mitigation module 17 can include an outage mitigator 48. The outage mitigator 48 can handle mitigation of predicted outages described by the prediction output 44. To do so, the outage mitigator 48 can include a causative module identifier 50. The causative module identifier 50 can identify whether particular modules of the cloud modules 20 are causative of the predicted outage. For example, assume that the prediction output 44 indicates that an outage is predicted to occur imminently for the cloud computing platform 18. Based on the prediction output 44, and/or the model output(s) 40, the outage mitigator 48 can identify the cloud compute module 20-1 as being causative of the predicted outage (e.g., due to a fault at the cloud compute module 20-1 described in the model output(s) 40, etc.).

To do so, the causative module identifier 50 can obtain, or generate, module mapping information 52. The module mapping information 52 can describe relationships or interactions between each of the cloud modules 20. For example, the module mapping information 52 can indicate that the compute module 20-1 interfaces with the cloud storage module 20-2 to retrieve datasets for compute tasks. For another example, the module mapping information 52 can indicate that the cloud virtualization module 20-4 often instantiates and/or de-instantiates instances of virtual network devices or security devices in response to requests from the cloud network/security module 20-3. Additionally, or alternatively, in some implementations, the module mapping information 52 can describe operations typically performed by each of the cloud modules 20. In this manner, the module mapping information 52 can be leveraged to identify target modules for mitigation.

As such, the causative module identifier 50 can include target module information 54. The causative module identifier 50 can generate the target module information 54 based on the module mapping information 52. The target module information 54 can identify causative modules and/or impacted modules (e.g., as identified by the causative module identifier 50 based on the module mapping information 52). For example, assume that the prediction output 44 indicates that an outage event is likely to occur for the cloud storage module 20-2. Based on the module mapping information 52 which indicates that the cloud compute module 20-1 often interfaces with the cloud storage module 20-2, the target module information 54 may list the cloud storage module 20-2 as a causative module and the cloud compute module 20-1 as an impacted module. In some implementations, the target module information 54 can indicate that the entire cloud computing platform 18 is impacted. For example, if the cloud virtualization module 20-4 experiences a fault, and the cloud computing platform 18 cannot offer basic functions and services without access to the cloud virtualization module 20-4, the target module information 54 may list each other cloud module of the cloud modules 20 and/or the cloud computing platform 18 itself as impacted modules.

The outage mitigator 48 can include a mitigation generator 56. The mitigation generator 56 can generate modifications 58 to mitigate the outage event indicated by the prediction output 44. The modifications 58 can modify the configuration of the target cloud modules indicated by the target module information 54 (e.g., the impacted and/or causative modules). For example, assume that the prediction output 44 indicates that the cloud storage module 20-2 will imminently experience an outage event caused by a lack of storage resources. Further assume that the target module information 54 lists the cloud compute module 20-1 as an impacted module and the cloud storage module 20-2 as a causative module. The modifications 58 can modify the configuration of the cloud compute module 20-1 to utilize a backup storage module until functionality is restored to the cloud storage module 20-2. The modifications can further modify the configuration of the cloud storage module 20-2 to increase the storage resources available to the cloud storage module 20-2. In such fashion, implementations described herein can modify the configuration of both causative cloud modules and impacted cloud modules to dynamically mitigate (or obviate) the impact of predicted outage events.

To follow the previous example, assume that the modifications 58 are generated prior to the occurrence of the predicted outage event. If the prediction output 44 indicates that a quantity of time between a current time and the predicted occurrence of the outage event is sufficient, the mitigation generator 56 can generate the modifications 58 to increase available storage resources for the cloud storage module 20-2 such that the predicted outage event never occurs. In this manner, implementations described herein can obviate the impact of predicted outage events entirely.

In some implementations, the modifications 58 can be modifications to a source code of one (or more) of the cloud modules 20. For example, the mitigation generator 56 can include a source code repository 60 that includes source code for each of the cloud modules 20. The modifications 58 can be generated based on the source code stored to the source code repository 60. Alternatively, the mitigation generator 56 may retrieve the source code from an external code repository 61 (e.g., repositories implemented by the creators of third-party cloud modules, etc.).

In some implementations, the mitigation generator 56 can include, or otherwise access, machine-learned model(s) in coordination with the machine learning module 28. The mitigation generator 56 can leverage the machine-learned model (e.g., the module-agnostic LFM 30, etc.) to generate the modifications 58. For example, the modifications 58 can be a generate output of the module-agnostic LFM 30 or a separate instance of the module-agnostic LFM 30.

The outage mitigator 48 can include a deployment handler 62. The deployment handler 62 can handle deployment of the modifications 58 to the cloud modules 20 identified by the target module information 54. For example, assume that the modifications 58 modify the configuration of the cloud compute module 20-1. In some instances, the deployment handler 62 may deploy the modifications 58 by directly applying the modifications 58 to the configuration of the cloud compute module 20-1. Alternatively, the deployment handler 62 may deploy the modifications 58 indirectly by providing the modifications 58 to the C/I module 24 for application to the configuration of the cloud compute module 20-1 (e.g., the C/I information 26, etc.). If the cloud module in question is an external cloud module 64, the deployment handler 62 may deploy the modifications 58 indirectly by providing the modifications 58 to the external cloud module 64 and/or to a computing system associated with an entity that implements the external cloud module 64 (e.g., a developer of the external cloud module 64, etc.).

In some implementations, the outage mitigator 48 can include a test module 66. The test module 66 can test the modifications 58 prior to application of the modifications 58. The test module 66 can perform any type or manner of tests to test the modifications 58, such as performing unit tests, executing a test suite 68, generating new tests using a test generator 70, processing the modifications 58 with a model (e.g., the module-agnostic LFM 30) alongside instructions to evaluate the modifications 58 for errors, etc.

For example, assume that the modifications 58 modify the configuration of the cloud network/security module 20-3. The test module 66 can instantiate a test instance of the cloud network/security module 20-3 and generate a test suite for the cloud network/security module 20-3 with the test generator 70. Alternatively, the test module 66 can obtain the test suite 68 (e.g., from a set of tests created during development of the module, etc.). The test module 66 can apply the modifications 58 to the test instance of the cloud network/security module 20-3 and then execute the test suite 68. Based on the results of the test suite 68, the test module 66 can determine whether to reject or approve the modifications 58. For example, the test module 66 may determine to approve the modifications 58 if the results of the test suite 68 indicate that the modifications 58 mitigate the outage event without introducing errors or vulnerabilities.

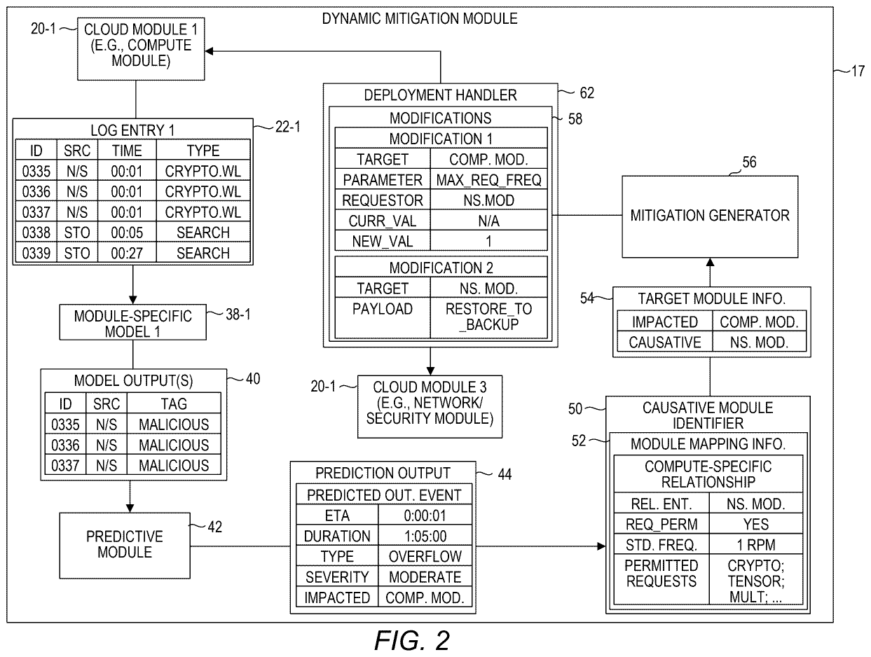

FIG. 2 is a data flow diagram for dynamically mitigating the impact of a predicted outage event on a cloud computing platform by modifying the configuration of impacted and causative cloud modules according to some implementations of the present disclosure. FIG. 2 will be discussed in conjunction with FIG. 1. In particular, to follow the depicted example, the log entry 22-1 can be generated for the cloud compute module 20-1. The log entry 22-1 can describe a list of requests received by the cloud compute module 20-1. For example, the log entry 22-1 can indicate that the cloud compute module 20-1 concurrently received three requests to perform cryptographic compute operations from the cloud network/security module 20-3. The log entry 22-1 can further indicate that the cloud compute module 20-1 subsequently received requests from the cloud storage module 20-2 and the machine learning module 28.

The module-specific model 38-1 for the cloud compute module 20-1 can process the log entry 22-1 to generate a model output 40. The model output 40 can associate “malicious” tags to the three cryptographic compute requests received from the cloud network/security module 20-3. For example, if the module-specific model 38-1 has been trained on prior log entries for the cloud compute module 20-1, and few (if any) of the prior log entries describe receipt of three concurrent requests from the cloud network/security module 20-3, the module-specific model 38-1 can determine that the three concurrent requests are likely to be malicious.

The predictive module 42 can process the model output(s) 40 to generate a prediction output 44. The prediction output 44 can predict an occurrence of an imminent outage event for the cloud compute module 20-1. Specifically, the prediction output 44 can indicate that an “OVERFLOW” type outage event is likely to occur in the next minute with a “moderate” severity and a duration of 1:05:15. The prediction output 44 can also indicate that the outage event is likely to occur at the cloud compute module 20-1. However, in some other instances, the prediction output 44 may not specifically identify the module(s) at which the outage event is predicted to occur. In such instances, the prediction output 44 may instead indicate that an outage will occur somewhere in the cloud computing platform 18 and/or that the outage will occur for the entirety of the cloud computing platform 18.

The causative module identifier 50 can process the prediction output 44 based on the module mapping information 52. In particular, the module mapping information 52 can indicate that requesting completion of a cryptographic workload is a known relation between the cloud network/security module 20-3 and the cloud compute module 20-1. However, the module mapping information 52 can further indicate that such requests are only sent at a frequency of one per minute at most. Based on the difference between the observed behavior of the cloud network/security module 20-3 and the module mapping information 52, the cloud network/security module 20-3 can generate target module information 54.

The target module information 54 can identify the cloud compute module 20-1 as an “impacted” module (e.g., will experience an outage event or will be affected by an outage event) and further identify the cloud network/security module 20-3 as the “causative” module (e.g., responsible for causing the outage event that affects the cloud compute module 20-1). Specifically, the target module information 54 can indicate that the concurrent cryptographic processing requests caused a buffer overflow that, in turn, will cause the predicted outage event.

To mitigate the predicted outage event, the mitigation generator 56 can process the target module information 54 to generate the modifications 58. The modifications 58 can modify the cloud compute module 20-1 to limit the number of requests to complete from the cloud network/security module 20-3. In this manner, the mitigation generator 56 can mitigate the risk of future outage events caused by overloading the cloud compute module 20-1 with requests. Further, if the modifications 58 are deployed prior to completion of the requests, the mitigation generator 56 can mitigate the occurrence of the outage event entirely.

The modifications 58 can also modify the cloud network/security module 20-3 by instructing the cloud network/security module 20-3 to restore from a prior backup. This can be based on the target module information 54 and the model output(s) 40, which indicate that the requests sent from the cloud network/security module 20-3 are likely malicious. In this instance, by restoring the cloud network/security module 20-3 to a backup, the modifications 58 can potentially mitigate future malicious attacks by restoring the cloud network/security module 20-3 to a point prior to when the behavior of the cloud network/security module 20-3 was maliciously modified.

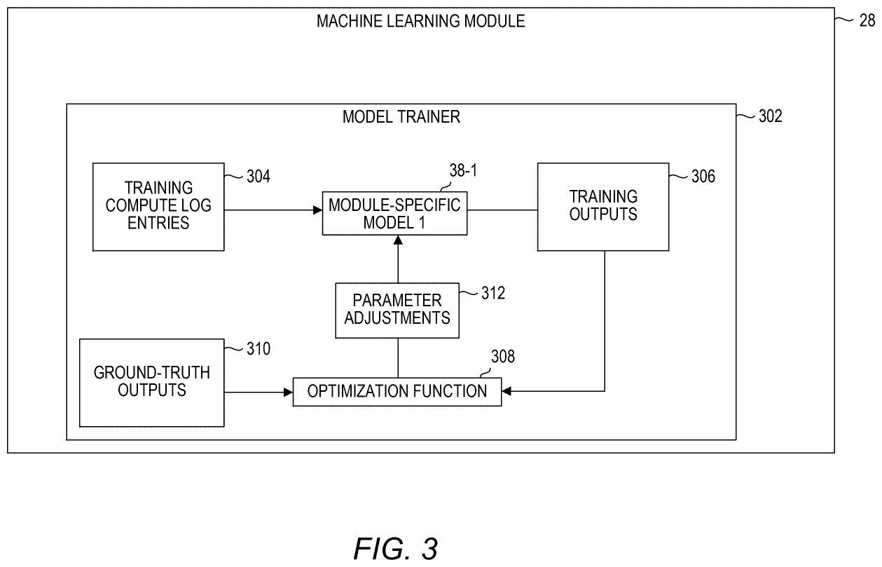

FIG. 3 is a data flow diagram data flow diagram for training a machine-learned model to parse module-specific log entries for predicting outage events on a cloud computing platform according to some implementations of the present disclosure. FIG. 3 will be discussed in conjunction with FIG. 1. Specifically, in some implementations, the machine learning module 28 can include a model trainer 302. The model trainer 302 can be utilized to train machine-learned models, such as the module-specific models 38, the module-agnostic LFM 30, etc. For example, the model trainer 302 can perform various model training algorithm(s) (e.g., backpropagation, gradient descent, etc.) to adjust parameter(s) of the machine-learned model(s), thereby training the model based on training data.

To do so, the model trainer 302 can obtain training compute log entries 304. The training compute log entries 304 can be log entries generated previously for (or by) the cloud compute module 20-1. The model trainer 302 can process the training compute log entries 304 to obtain training outputs 306. The training outputs 306 can be the same type of output as the model outputs 40 described with regards to FIG. 1. For example, the training outputs 306 can include certain portions of the training compute log entries 304, an analysis of the training compute log entries 304, etc.

The model trainer 302 can be utilized to train the module-specific model 38-1. Like the other module-specific models 38, the module-specific model 38-1 can be any type or manner of machine-learned model, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

The model trainer 302 can train the module-specific model 38-1 using any type or manner of training or learning technique, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, performing backwards propagation of errors can include performing truncated backpropagation through time. The model trainer 160 can perform a number of generalization techniques (e.g., weight decays, dropouts, etc.) to improve the generalization capability of the models being trained.

The model trainer 302 can train the model by evaluating the training outputs 306 with an optimization function 308. In some implementations, the model trainer 302 can utilize an unsupervised training process to train the module-specific model 38-1. For example, the module-specific model 38-1 can be a type of unsupervised model (e.g., a variational autoencoder, etc.) and the optimization function 308 can be an unsupervised learning type optimization function (e.g., K-means clustering, dimensionality reduction, etc.).

Alternatively, in some implementations, the model trainer 302 can utilize a supervised, semi-supervised, weakly supervised, etc. training process. To do so, the model trainer 302 can obtain ground truth outputs 310 alongside the training compute log entries 304. The ground truth outputs 310 can be “correct” or verified outputs corresponding to the training compute log entries 304. The optimization function 308 can evaluate a difference between the ground truth outputs 310 and the training output 306. Based on the optimization function 308, the model trainer can generate parameter adjustments 312 and apply the parameter adjustments to the module-specific model 38-1. In such fashion, implementations described herein can train multiple machine-learned models (or multiple instances of a common model, such as the module-agnostic LFM 30, to process log entries from a particular type of cloud computing module.

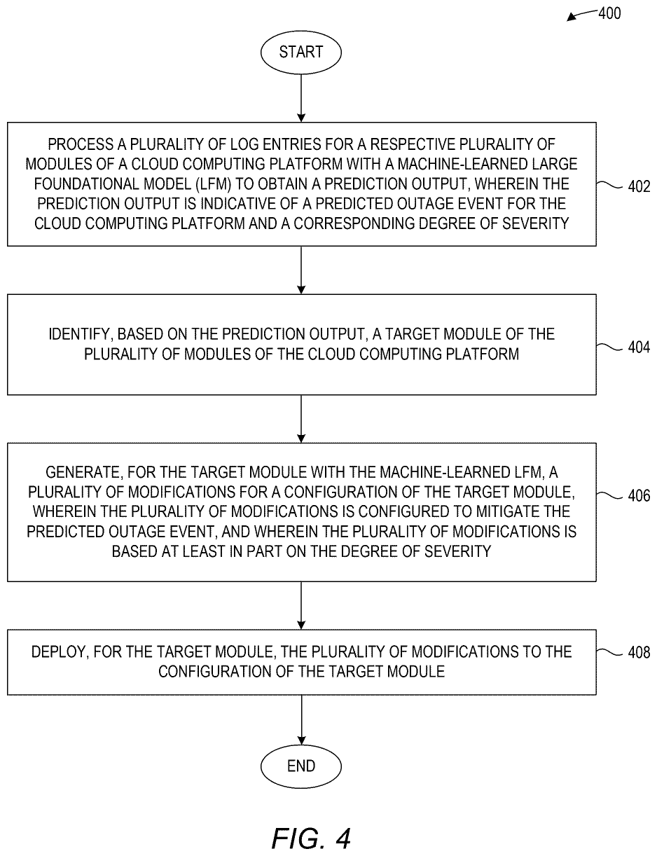

FIG. 4 depicts a flow chart diagram of an example method 400 to perform dynamic mitigation of cloud infrastructure to mitigate predicted outages according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can process a plurality of log entries for a respective plurality of modules of a cloud computing platform with a machine-learned LFM to obtain a prediction output. The prediction output can be indicative of a predicted outage event for the cloud computing platform and a corresponding degree of severity.

In some implementations, the machine-learned LFM can be one of a plurality of machine-learned LFMs. To process the plurality of log entries, the computing system can process, with a first machine-learned LFM of the plurality of machine-learned LFMs, a first log entry of the plurality of log entries for a first module of the plurality of modules of the cloud computing platform to obtain a first prediction sub-output. The computing system can process, with a second machine-learned LFM of the plurality of machine-learned LFMs, a second log entry of the plurality of log entries for a second module of the plurality of modules of the cloud computing platform to obtain a second prediction sub-output. The computing system can generate the prediction output based on the first prediction sub-output and the second prediction sub-output.

In some implementations, the first machine-learned LFM of the plurality of machine-learned LFMs can be a first instance of the machine-learned LFM prompted with a first prompt that includes contextual information associated with a function of the first module of the plurality of modules of the cloud computing platform. The second machine-learned LFM of the plurality of machine-learned LFMs can be the first instance of the machine-learned LFM prompted with a second prompt that includes contextual information associated with a function of the second module of the plurality of modules of the cloud computing platform.

In some implementations, the function of the first module can be a compute function, a storage function, a network and security function, a virtualization function, a cloud platform configuration function, etc.

In some implementations, prior to processing the first log entry of the plurality of log entries with the first machine-learned LFM of the plurality of machine-learned LFMs, the computing system can train the first machine-learned LFM based at least in part on contextual information associated with a function of the first module of the plurality of modules of the cloud computing platform.

At 404, the computing system can identify, based on the prediction output, a target module of the plurality of modules of the cloud computing platform. In some implementations, to identify the target module, the computing system can obtain, based on the prediction output, module mapping information descriptive of existing relationships between the plurality of modules of the cloud computing platform. The computing system can identify the one or more target modules based on the prediction output and the module mapping information. In some implementations, the module mapping information can include source code for the one or more target modules.

At 406, for the target module, the computing system can generate, with the machine-learned LFM, a plurality of modifications for a configuration of the target module. The plurality of modifications can be configured to mitigate the predicted outage event. The modifications can be based at least in part on the degree of severity.

In some implementations, to generate the prediction output, the computing system can process the first prediction sub-output and the second prediction sub-output with the machine-learned LFM to obtain the prediction output. Alternatively, in some implementations, to generate the prediction output, the computing system can generate modifications to a unit of software instructions that implements the target module with the machine-learned LFM. The modifications can be configured to mitigate the predicted outage event.

At 408, for the target module, the computing system can deploy the plurality of modifications to the configuration of the target module. In some implementations, to deploy the plurality of modifications, the computing system can deploy the plurality of modifications to the configuration of the target module prior to occurrence of the predicted imminent outage event. For example, the target module can be an affected or impacted module (e.g., suffering performance degradation due to the predicted outage event or predicted to do so), and the modifications deployed prior to the predicted outage event can mitigate the effects of the outage event.

In some implementations, the computing system can further execute a test suite associated with the target module to validate the modifications to the configuration of the target module.

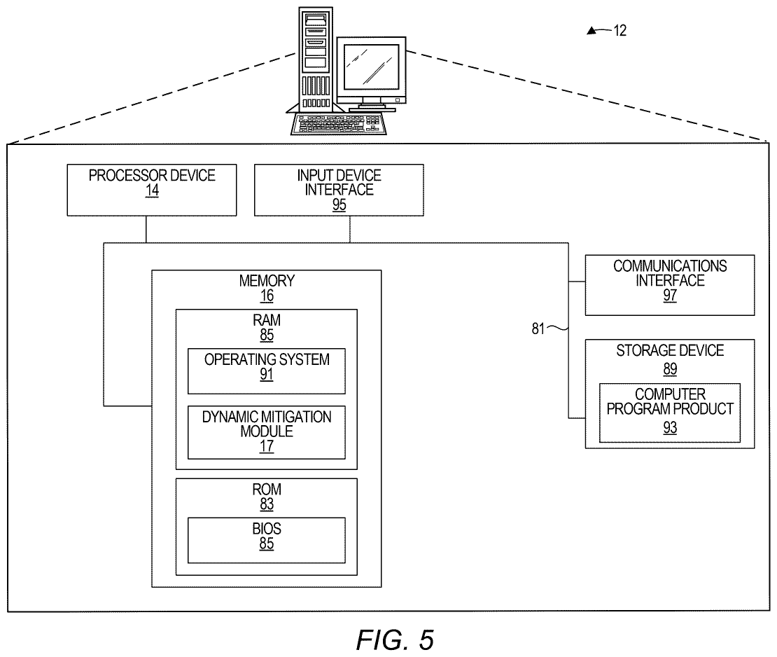

FIG. 5 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 81. The system bus 81 provides an interface for system components including, but not limited to, the memory 16 and the processor device(s) 14. The processor device(s) 14 can be any commercially available or proprietary processor.

The system bus 81 may be any of several types of bus structures that may further interconnect to a memory bus (with or without a memory controller), a peripheral bus, and/or a local bus using any of a variety of commercially available bus architectures. The memory 16 may include non-volatile memory 83 (e.g., read-only memory (ROM), erasable programmable read-only memory (EPROM), electrically erasable programmable read-only memory (EEPROM), etc.), and volatile memory 85 (e.g., random-access memory (RAM)). A basic input/output system (BIOS) 87 may be stored in the non-volatile memory 83 and can include the basic routines that help to transfer information between elements within the computing system 12. The volatile memory 85 may also include a high-speed RAM, such as static RAM, for caching data.

The computing system 12 may further include or be coupled to a non-transitory computer-readable storage medium such as the storage device 89, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 89 and other drives associated with computer-readable media and computer-usable media may provide non-volatile storage of data, data structures, computer-executable instructions, and the like.

A number of modules can be stored in the storage device 89 and in the volatile memory 85, including an operating system 91 and one or more program modules, such as the dynamic mitigation module 17, which may implement the functionality described herein in whole or in part. All or a portion of the examples may be implemented as a computer program product 93 stored on a transitory or non-transitory computer-usable or computer-readable storage medium, such as the storage device 89, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the dynamic mitigation module 17 in the volatile memory 85, may serve as a controller, or control system, for the computing system 12 that is to implement the functionality described herein.

Because the dynamic mitigation module 17 is a component of the computing system 12, functionality implemented by the dynamic mitigation module 17 may be attributed to the computing system 12 generally. Moreover, in examples where the dynamic mitigation module 17 comprises software instructions that program the processor device(s) 14 to carry out functionality discussed herein, functionality implemented by the dynamic mitigation module 17 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 95 that is coupled to the system bus 81 but can be connected by other interfaces such as a parallel port, an Institute of Electrical and Electronic Engineers (IEEE) 1394 serial port, a Universal Serial Bus (USB) port, an IR interface, and the like. The computing system 12 may also include the communications interface 97 suitable for communicating with the network as appropriate or desired. The computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

1. A method, comprising:
processing, by a computing system comprising one or more processor devices, a plurality of log entries for a respective plurality of modules of a cloud computing platform with a machine-learned Large Foundational Model (LFM) to obtain a prediction output, wherein the prediction output is indicative of a predicted outage event for the cloud computing platform and a corresponding degree of severity;
identifying, by the computing system based on the prediction output, a target module of the plurality of modules of the cloud computing platform; and
for the target module:
generating, by the computing system with the machine-learned LFM, a plurality of modifications for a configuration of the target module, wherein the plurality of modifications is configured to mitigate the predicted outage event, wherein the plurality of modifications comprises a modification to a variable of the configuration for the target module that controls a maximum number of actions of a particular type performed by the target module, and wherein the plurality of modifications is based at least in part on the degree of severity; and
deploying, by the computing system, the plurality of modifications to the configuration of the target module.

2. The method of claim 1, wherein generating the plurality of modifications for the configuration of the target module further comprises:
executing, by the computing system, a test suite associated with the target module to validate the plurality of modifications to the configuration of the target module.

3. The method of claim 1, wherein the machine-learned LFM comprises one of a plurality of machine-learned LFMs, and wherein processing the plurality of log entries for the respective plurality of modules of the cloud computing platform with the machine-learned LFM to obtain the prediction output comprises:
processing, by the computing system with a first machine-learned LFM of the plurality of machine-learned LFMs, a first log entry of the plurality of log entries for a first module of the plurality of modules of the cloud computing platform to obtain a first prediction sub-output;
processing, by the computing system with a second machine-learned LFM of the plurality of machine-learned LFMs, a second log entry of the plurality of log entries for a second module of the plurality of modules of the cloud computing platform to obtain a second prediction sub-output; and
generating, by the computing system, the prediction output based on the first prediction sub-output and the second prediction sub-output.

4. The method of claim 3, wherein the first machine-learned LFM of the plurality of machine-learned LFMs comprises a first instance of the machine-learned LFM prompted with a first prompt comprising contextual information associated with a function of the first module of the plurality of modules of the cloud computing platform; and
wherein the second machine-learned LFM of the plurality of machine-learned LFMs comprises the first instance of the machine-learned LFM prompted with a second prompt comprising contextual information associated with a function of the second module of the plurality of modules of the cloud computing platform.

5. The method of claim 4, wherein the function of the first module comprises:
a compute function;
a storage function;
a network and security function;
a virtualization function; or
a cloud platform configuration function.

6. The method of claim 3, wherein, prior to processing the first log entry of the plurality of log entries with the first machine-learned LFM of the plurality of machine-learned LFMs, the method comprises:
training, by the computing system, the first machine-learned LFM based at least in part on contextual information associated with a function of the first module of the plurality of modules of the cloud computing platform.

7. The method of claim 3, wherein generating the prediction output based on the first prediction sub-output and the second prediction sub-output comprises:
processing, by the computing system, the first prediction sub-output and the second prediction sub-output with the machine-learned LFM to obtain the prediction output.

8. The method of claim 1, wherein identifying the target module of the plurality of modules of the cloud computing platform comprises:
obtaining, by the computing system based on the prediction output, module mapping information descriptive of existing relationships between the plurality of modules of the cloud computing platform; and
identifying, by the computing system, the target module based on the prediction output and the module mapping information.

9. The method of claim 8, wherein the module mapping information comprises source code for the target module.

10. The method of claim 8, wherein the module mapping information comprises technical documentation associated with the target module.

11. The method of claim 1, wherein generating the plurality of modifications for the configuration of the target module comprises:
generating, by the computing system with the machine-learned LFM, the plurality of modifications, wherein the plurality of modifications comprises a modification to a unit of software instructions that implements the target module, wherein the modification is configured to mitigate the predicted outage event.

12. The method of claim 1, wherein deploying the plurality of modifications to the configuration of the target module comprises:
deploying, by the computing system, the plurality of modifications to the configuration of the target module prior to occurrence of the predicted outage event.

13. The method of claim 1, wherein the target module comprises an impacted module impacted by the predicted outage event, and wherein the modifications mitigate an impact of the predicted outage event prior to occurrence of the predicted outage event.

14. The method of claim 13, wherein the target module comprises a causative module that is causative of the predicted outage event.

15. A computing system comprising:
one or more processor devices to:
process a plurality of log entries for a respective plurality of modules of a cloud computing platform with a machine-learned Large Foundational Model (LFM) to obtain a prediction output, wherein the prediction output is indicative of a predicted outage event for the cloud computing platform and a corresponding degree of severity;
identify, based on the prediction output, a target module of the plurality of modules of the cloud computing platform; and
for the target module:
generate, with the machine-learned LFM, a plurality of modifications for a configuration of the target module, wherein the plurality of modifications comprises a modification to a variable of the configuration for the target module that controls a maximum number of actions of a particular type performed by the target module, wherein the plurality of modifications is configured to mitigate the predicted outage event, and wherein the plurality of modifications is based at least in part on the degree of severity; and
deploy the plurality of modifications to the configuration of the target module.

16. The computing system of claim 15, wherein, to generate the plurality of modifications for the configuration of the target module, the one or more processor devices are to:
execute a test suite associated with the target module to validate the plurality of modifications to the configuration of the target module.

17. The computing system of claim 15, wherein the machine-learned LFM comprises one of a plurality of machine-learned LFMs, and wherein, to process the plurality of log entries for the respective plurality of modules of the cloud computing platform with the machine-learned LFM to obtain the prediction output, the one or more processor devices are to:
process, with a first machine-learned LFM of the plurality of machine-learned LFMs, a first log entry of the plurality of log entries for a first module of the plurality of modules of the cloud computing platform to obtain a first prediction sub-output;
process, with a second machine-learned LFM of the plurality of machine-learned LFMs, a second log entry of the plurality of log entries for a second module of the plurality of modules of the cloud computing platform to obtain a second prediction sub-output; and
generate the prediction output based on the first prediction sub-output and the second prediction sub-output.

18. The computing system of claim 17, wherein the first machine-learned LFM of the plurality of machine-learned LFMs comprises a first instance of the machine-learned LFM prompted with a first prompt comprising contextual information associated with a function of the first module of the plurality of modules of the cloud computing platform; and
wherein the second machine-learned LFM of the plurality of machine-learned LFMs comprises the first instance of the machine-learned LFM prompted with a second prompt comprising contextual information associated with a function of the second module of the plurality of modules of the cloud computing platform.

19. The computing system of claim 18, wherein the function of the first module comprises:
a compute function;
a storage function;
a network and security function;
a virtualization function; or
a cloud platform configuration function.

20. A non-transitory computer-readable storage medium that includes executable instructions to cause one or more processor devices to:
process a plurality of log entries for a respective plurality of modules of a cloud computing platform with a machine-learned Large Foundational Model (LFM) to obtain a prediction output, wherein the prediction output is indicative of a predicted outage event for the cloud computing platform and a corresponding degree of severity;
identify, based on the prediction output, a target module of the plurality of modules of the cloud computing platform; and
for the target module:
generate, with the machine-learned LFM, a plurality of modifications for a configuration of the target module, wherein the plurality of modifications comprises a modification to a variable of the configuration for the target module that controls a maximum number of actions of a particular type performed by the target module, wherein the plurality of modifications is configured to mitigate the predicted outage event, and wherein the plurality of modifications is based at least in part on the degree of severity; and
deploy the plurality of modifications to the configuration of the target module.
